(19) United States
(12) Patent Application Publication
(10) Pub. No.: US 2026/0091315 A1
(43) Pub. Date: Apr. 2, 2026

(54) VIDEO GAME ASSISTANT

(71) Applicant: Electronic Arts Inc., Redwood City, CA (US)

(72) Inventors: Zian Wang, Redwood City, CA (US); Teng Wang, Foster City, CA (US); Yu Jin, Fremont, CA (US); Yuyang Luo, Mountain View, CA (US); Yen Feng, Kirkland, WA (US); Dilip Varadarajan, Cupertino, CA (US)

(21) Appl. No.: 18/901,285

(22) Filed: Sep. 30, 2024

(51) Int. Cl. A63F 13/533

(52) U.S. Cl. CPC A63F 13/533

(57) ABSTRACT

A method includes receiving runtime data from a gameplay session by a player of a video game and providing the runtime data from the gameplay session of the video game as an input to a gameplay model. The method further includes, responsive to providing the input, receiving output data from the gameplay model, and using the output data, generating an audio stream describing a context of the gameplay session. The method further includes providing the audio stream to the player of the video game during the gameplay session.

### TECHNICAL FIELD

The present disclosure generally relates to video games, and more particularly to artificial intelligence assistants in video games.

### BACKGROUND

Players with vision impairments may encounter difficulties in comprehending contextual information from video content while playing video games, and as a result, feel less engaged with such games. This often necessitates a greater reliance on audio output to better understand a game's current state. However, as games become more socially connected and accessible, those associated features can create additional audio streams that overlap with existing ones (e.g., Non-Player Characters (NPCs), Team Chat, Screen Readers, Environment Sounds), which can overwhelm a player trying to interpret context from them all. Moreover, a user needing vision assistance may not be able to operate a mouse or touchpad to move their game characters precisely.

Screen readers have been used to address this problem, wherein the player moves their mouse around the screen, and sentences on the screen may be read into audio. However, the screen description may be mixed with game audio, which may be noisy and difficult to distinguish. Furthermore, the information in on-screen words may not be enough for the player to fully engage with the game, since this would omit character movements, object distances, directions for movement, and the like.

Human assistants have also been used, where a player with a vision impairment pairs with another player who can then provide audio guidance and instant instruction as needed. However, this approach relies on the assisting player's opinion, which interferes with their own decision making, and the assisting player may not always be available.

As such, there is a need for improved solutions for effectively communicating game context, especially to players with vision impairments.

### SUMMARY

Some embodiments of the present disclosure provide a method. The method includes receiving runtime data from a gameplay session by a player of a video game and providing the runtime data from the gameplay session of the video game as an input to a gameplay model. The method further includes, responsive to providing the input, receiving output data from the gameplay model, and using the output data, generating an audio stream describing one or more contexts corresponding to the gameplay session. The method further includes providing the audio stream to the player of the video game during the gameplay session.

Some embodiments of the present disclosure provide a non-transitory computer-readable medium storing a program, which when executed by a computer, configures the computer to receive runtime data from a gameplay session by a player of a video game and to provide the runtime data from the gameplay session of the video game as an input to a gameplay model. The program, when executed, further configures the computer to receive output data from the gameplay model responsive to providing the input, and using the output data, to generate an audio stream describing one or more contexts corresponding to the gameplay session. The program, when executed, further configures the computer to provide the audio stream to the player of the video game during the gameplay session.

Some embodiments of the present disclosure provide a system that includes a processor and a non-transitory computer-readable medium storing a set of instructions, which when executed by the processor, configure the system to receive runtime data from a gameplay session by a player of a video game, and to provide the runtime data from the gameplay session of the video game as an input to a gameplay model. The instructions, when executed by the processor, further configure the system to receive output data from the gameplay model, responsive to providing the input. The instructions, when executed by the processor, further configure the system to generate an audio stream describing one or more contexts corresponding to the gameplay session using the output data, and to provide the audio stream to the player of the video game during the gameplay session.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments.

FIG. 1 illustrates a network architecture used to provide assistance to video game players, according to some embodiments.

FIG. 2 is a block diagram illustrating details of a system for providing assistance to video game players, according to some embodiments.

FIG. 3 is a flowchart illustrating a process for training and using a gameplay model for video game assistance.

FIG. 4 is a block diagram illustrating a system for training and using a gameplay model for video game assistance, according to some embodiments.

FIG. 5A shows an example where a player playing a sports game has selected live game status and teammate updates but has not chosen recommendations, according to some embodiments.

FIG. 5B shows an example where a player playing a sports game has selected live game status, teammate updates, and recommendations, according to some embodiments.

FIG. 5C shows an example where a player playing a sports game has selected live game status but has not chosen teammate updates or recommendations, according to some embodiments.

FIG. 6A shows an example where a player playing a fantasy game has selected live game status and teammate updates but has not chosen recommendations, according to some embodiments.

FIG. 6B shows an example where a player playing a fantasy game has selected live game status, teammate updates, and recommendations, according to some embodiments.

FIG. 6C shows an example where a player playing a fantasy game has selected live game status but has not chosen teammate updates or recommendations, according to some embodiments.

FIG. 6D shows an example where the player has selected teammate updates but has not chosen live game updates or recommendations.

FIG. 6E shows an example where the player has selected recommendations but has not chosen live game status or teammate updates.

FIG. 7 is a block diagram illustrating an exemplary computer system with which aspects of the subject technology can be implemented, according to some embodiments.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

All references cited anywhere in this specification, including the Background and Detailed Description sections, are incorporated by reference as if each had been individually incorporated.

The term “user” as used herein refers to a person playing a video game. The person may be playing the video game using a user account or may be playing without an account. Users may be equivalently referred to as, or understood to be, “players,” “user accounts,”“accounts,” and the like.

Embodiments of the present disclosure address the above identified problems using a video game assistant (or, “assistant” in short) that consolidates a variety of information sources corresponding to a video game into a single audio stream, for communicating video game context and recommendations to video game players. This summarized audio stream may be beneficial to any video game player, including players with visual disabilities, such that it conveys context more efficiently and effectively to players. The audio stream may merge live game status and voices into a single stream of information and may even guide the operator with recommendations for movement, strategy, etc., based on the information sources being consolidated.

In some embodiments, the video game assistant is an accessibility feature or system that can be enabled and/or configured. The video game assistant can be configured to operate concurrently with a video game during a live or current gameplay session, such that the video game assistant can output real-time or near real-time summarized context or recommendations during gameplay.

In some embodiments, a video game assistant is software that can be included among, or added to, a video game. In other embodiments, a video game assistant is software that can be communicatively coupled to a video game. In some embodiments, a video game assistant can be configured to operate with or for a particular video game. For example, a particular version of a video game assistant can be trained and/or configured to operate with a particular video game, or version of a video game, to more accurately and/or effectively provide context and recommendations to players of that video game.

The summarized audio stream may in some embodiments include short audio messages that convey a summary of information being provided to the player on screen and which are, or otherwise would be, provided as game audio to the player. The short audio messages may also include instructions, recommendations, and/or gameplay advice. Such short audio messages could include, as an example for a combat game, “Enemy team is advancing, find cover,” “Enemy team is attacking your teammate within Area B, provide cover fire,” and “Opponents advancing on you, open players on pitch are mapped to A and X buttons.”

The video game assistant may be in some embodiments a trained artificial intelligence-driven assistant, based on neural net, machine learning, and/or large language model (LLM) technology.

In some embodiments, the video game assistant is a large language model (LLM) based system trained to monitor gameplay and/or social communications for consolidating and summarization of a variety of game contexts into a single simplified audio stream. The video game assistant may be trained on diverse datasets, including visual, audio, and text data relevant to a game.

In some embodiments, the audio stream provided by the video game assistant is player-configurable, allowing players to receive consolidated information for one or more monitored contexts. A monitored context can encompass any information conveyed during gameplay, including but not limited to some or all of game state, team chat, menu text, NPC statuses, subtitles, game audio, and character dialogue.

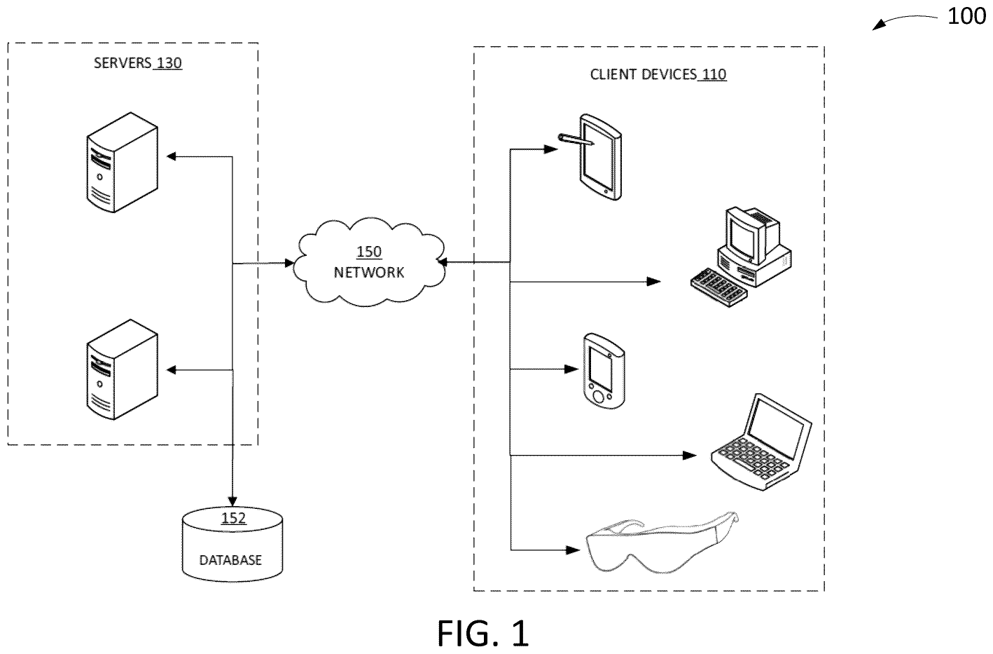

FIG. 1 illustrates a network architecture 100 used to provide assistance to video game players, according to some embodiments. The network architecture 100 may include one or more client devices 110 and servers 130, communicatively coupled via a network 150 with each other and to at least one database, e.g., database 152. Database 152 may store data and files associated with the servers 130 and/or the client devices 110. In some embodiments, client devices 110 collect data, videos, images, and the like, for upload to the servers 130 to store in the database 152.

The network 150 may include a wired network (e.g., fiber optics, copper wire, telephone lines, and the like) and/or a wireless network (e.g., a satellite network, a cellular network, a radiofrequency (RF) network, Wi-Fi, Bluetooth, and the like). The network 150 may further include one or more of a local area network (LAN), a wide area network (WAN), the Internet, and the like. Further, the network 150 may include, but is not limited to, any one or more of the following network topologies, including a bus network, a star network, a ring network, a mesh network, and the like.

Client devices 110 may include, but are not limited to, laptop computers, desktop computers, and mobile devices such as smart phones, tablets, televisions, wearable devices, head-mounted devices, display devices, and the like.

In some embodiments, the servers 130 may be a cloud server or a group of cloud servers. In other embodiments, some or all of the servers 130 may not be cloud-based servers (i.e., may be implemented outside of a cloud computing environment, including but not limited to an on-premises environment), or may be partially cloud-based. Some or all of the servers 130 may be part of a cloud computing server, including but not limited to rack-mounted computing devices and panels. Such panels may include but are not limited to processing boards, switchboards, routers, and other network devices. In some embodiments, the servers 130 may include the client devices 110 as well, such that they are peers.

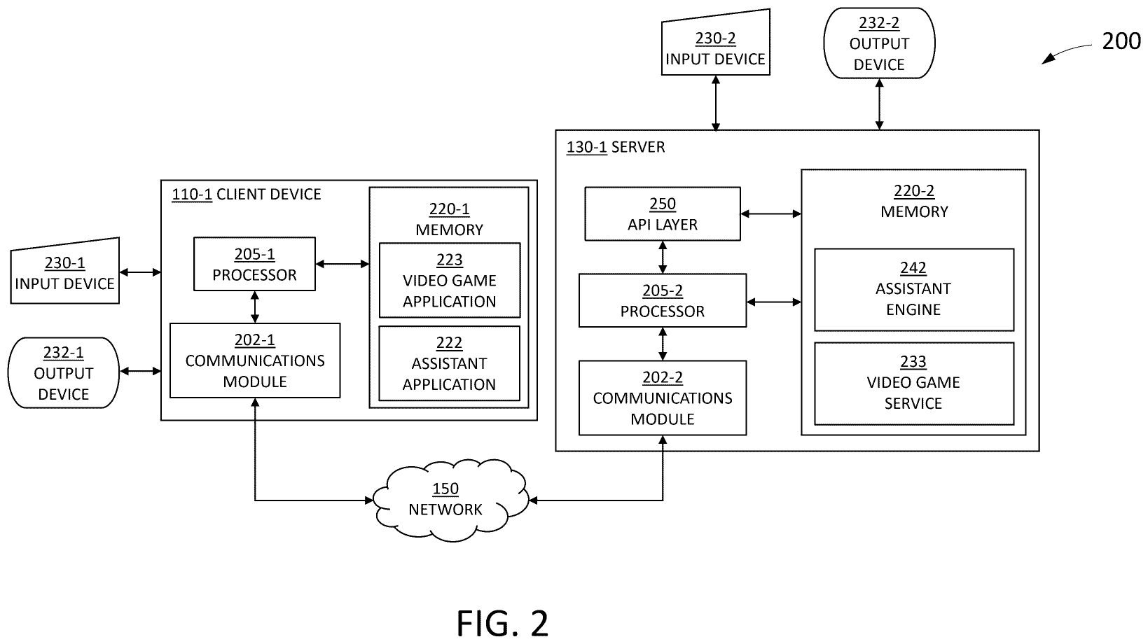

FIG. 2 is a block diagram illustrating details of a system 200 for providing assistance to video game players, according to some embodiments. Specifically, the example of FIG. 2 illustrates an exemplary client device 110-1 (of the client devices 110) and an exemplary server 130-1 (of the servers 130) in the network architecture 100 of FIG. 1.

Client device 110-1 and server 130-1 are communicatively coupled over network 150 via respective communications modules 202-1 and 202-2 (hereinafter, collectively referred to as “communications modules 202”). Communications modules 202 are configured to interface with network 150 to send and receive information, such as requests, data, messages, commands, and the like, to other devices on the network 150. Communications modules 202 can be, for example, modems or Ethernet cards, and/or may include radio hardware and software for wireless communications (e.g., via electromagnetic radiation, such as radiofrequency (RF), near field communications (NFC), Wi-Fi, and Bluetooth radio technology).

The client device 110-1 and server 130-1 also include processors 205-1 and 205-2 and memories 220-1 and 220-2, respectively. Processors 205-1 and 205-2 and memories 220-1 and 220-2 will be collectively referred to, hereinafter, as “processors 205” and “memories 220.” Processors 205 may be configured to execute instructions stored in memories 220, to cause client device 110-1 and/or server 130-1 to perform methods and operations consistent with embodiments of the present disclosure.

The client device 110-1 and the server 130-1 are each coupled to at least one input device 230-1 and input device 230-2, respectively (hereinafter, collectively referred to as “input devices 230”). The input devices 230 can include a mouse, a controller, a keyboard, a pointer, a stylus, a touchscreen, a microphone, voice recognition software, a joystick, a virtual joystick, a touch-screen display, and the like. In some embodiments, the input devices 230 may include cameras, microphones, sensors, and the like. In some embodiments, the sensors may include touch sensors, acoustic sensors, inertial motion units and the like.

The client device 110-1 and the server 130-1 are also coupled to at least one output device 232-1 and output device 232-2, respectively (hereinafter, collectively referred to as “output devices 232”). The output devices 232 may include a screen, a display (e.g., a same touchscreen display used as an input device), a speaker, an alarm, and the like. A user may interact with client device 110-1 and/or server 130-1 via the input devices 230 and the output devices 232.

Memory 220-1 may further include an assistant application 222, configured to execute on client device 110-1 and couple with input device 230-1 and output device 232-1. The assistant application 222 may be downloaded by the user from server 130-1, and/or may be hosted by server 130-1. The assistant application 222 may include specific instructions which, when executed by processor 205-1, cause operations to be performed consistent with embodiments of the present disclosure. In some embodiments, the assistant application 222 runs on an operating system (OS) installed in client device 110-1. In some embodiments, assistant application 222 may run within a web browser. In some embodiments, the processor 205-1 is configured to control a graphical user interface (GUI) (e.g., spanning at least a portion of input devices 230 and output devices 232) for the user of client device 110-1 to access the server 130-1.

In some embodiments, memory 220-2 includes an assistant engine 242. The assistant engine 242 may be configured to perform methods and operations consistent with embodiments of the present disclosure. The assistant engine 242 may share or provide features and resources with the client device 110-1, including data, libraries, and/or applications retrieved with assistant engine 242 (e.g., assistant application 222). The user may access the assistant engine 242 through the assistant application 222. The assistant application 222 may be installed in client device 110-1 by the assistant engine 242 and/or may execute scripts, routines, programs, applications, and the like provided by the assistant engine 242.

Memory 220-1 may further include a video game application 223, configured to execute in client device 110-1. The video game application 223 may communicate with video game service 233 in memory 220-2 to provide video game content to the user of client device 110-1. The video game application 223 may communicate with video game service 233 through application programming interface (API) layer 250, for example.

The assistant application 222 may communicate within memory 220-1 with video game application 223, and/or may communicate with video game service 233 in memory 220-2 (e.g., via API layer 250), according to some embodiments. The video game application 223 within memory 220-1 may communicate with the assistant engine 242 in memory 220-2, according to some embodiments. The assistant engine 242 may communicate within memory 220-2 with video game service 233, in some embodiments.

In some embodiments, assistant application 222 may be a component of video game application 223. In some embodiments, assistant engine 242 may be a component of video game service 233.

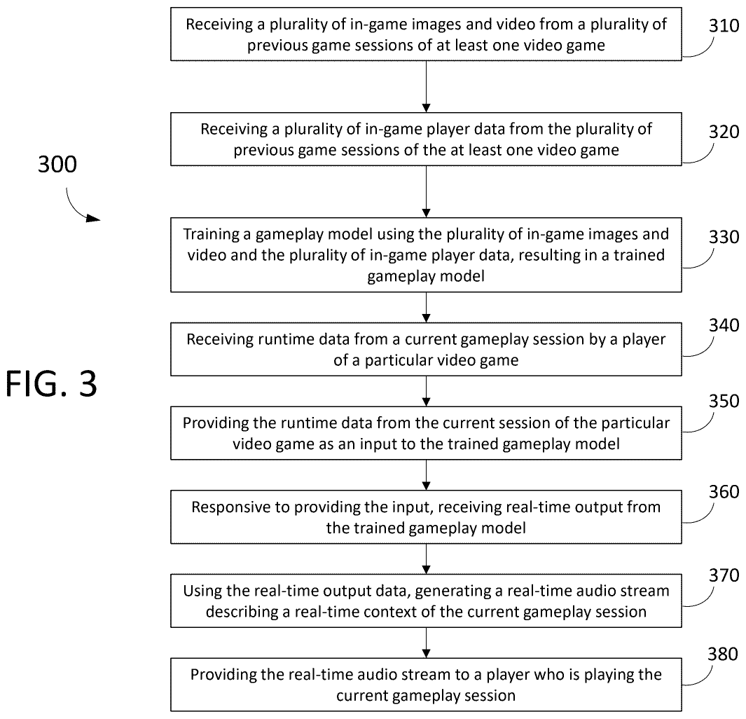

FIG. 3 is a flowchart illustrating a process 300 for training and using a gameplay model for video game assistance, performed by a client device (e.g., client device 110-1, etc.) and/or a client server (e.g., server 130-1, etc.), according to some embodiments. In some embodiments, one or more operations in process 300 may be performed by a processor circuit (e.g., processors 205, etc.) executing instructions stored in a memory circuit (e.g., memories 220, etc.) of a system (e.g., system 200, etc.) as disclosed herein. For example, operations in process 300 may be performed by assistant application 222, assistant engine 242, or some combination thereof. Moreover, in some embodiments, a process consistent with this disclosure may include at least operations in process 300 performed in a different order, simultaneously, quasi-simultaneously, or overlapping in time.

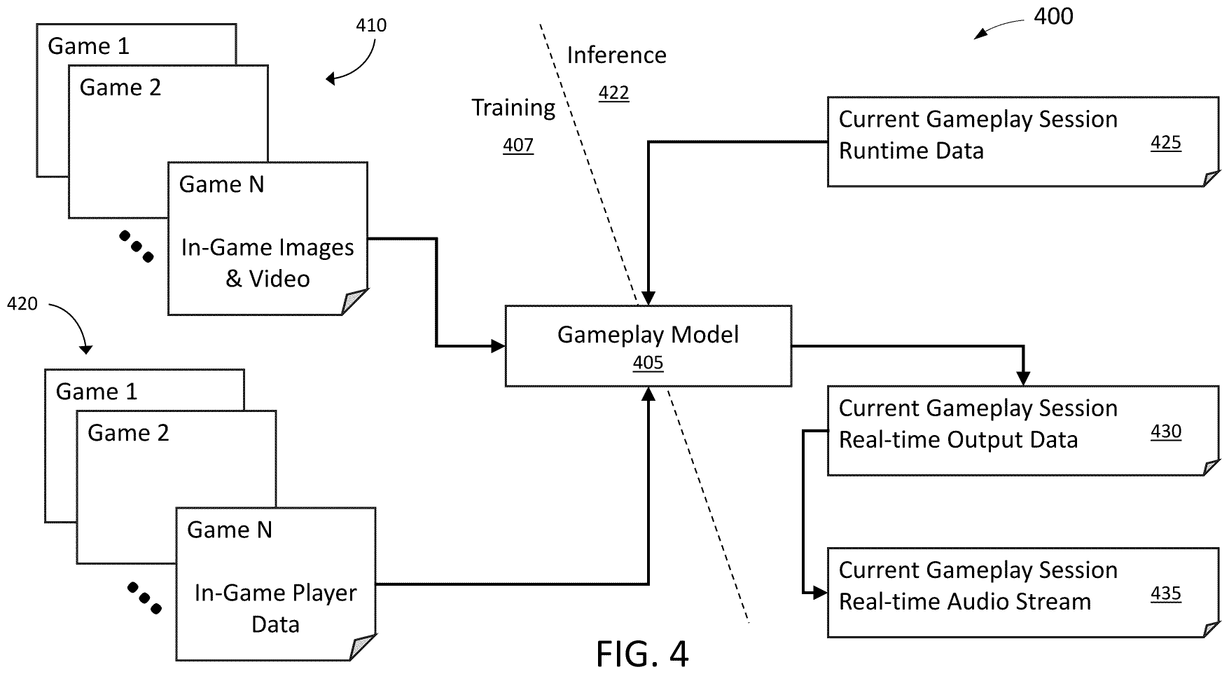

The process 300 will be discussed with reference to an exemplary example shown in FIG. 4, which is a block diagram illustrating a system 400 for training and using a gameplay model for video game assistance, according to some embodiments. The system 400 includes a gameplay model 405, that during a training phase 407, may be trained on at least in-game images and video 410 and in-game player data 420 from one or more of a plurality of video games. During an inference phase 422, the gameplay model 405 may receive as input, runtime data 425 from a gameplay session, and provide as an output, output data 430. The output data 430 may be used to generate an audio stream 435.

Returning to FIG. 3, at 310, the process 300 receives a plurality of in-game images and video (e.g., in-game images and video 410) from a plurality of previous game sessions of at least one video game.

In some embodiments, the in-game images and video depict game elements including but not limited to player characters (PCs), non-player characters (NPCs), game scenes, game locations, and actions by one or more PCs or NPCs.

As an example, for an American soccer video game, the images and video may include the following types of data: for each NPC and PC in the game, a corresponding picture and name; actions performed by the PC/NPC, such as shooting, left arm raised, left leg raised, etc. ; scenes, such as European, Asian, blue, green fields, etc. ; and field locations, such as left 1/2, right 1/3, corner, middle, etc.

At 320, the process 300 receives a plurality of in-game player data (e.g., in-game player data 420) from the plurality of previous game sessions of the at least one video game.

In some embodiments, the player data includes, but is not limited to, description of players'actions and locations, communications (audio conversations, chat messages, etc.) between players, and description of gameplay strategy by the players.

To continue the previous example of an American soccer video game, the player data may include the audience shouting “Hurray!” teammates saying to “turn right,” and a player on an opposing team saying they are running to a player's position.

At 330, the process 300 trains a gameplay model (e.g., gameplay model 405, during training phase 407) using at least the plurality of in-game images and video and the plurality of in-game contextual player data, resulting in a trained gameplay model (e.g., gameplay model 405, during inference phase 422).

In some embodiments, the gameplay model is one of a neural network, a machine-learning model, an artificial intelligence (AI) model, and/or a generative AI model. For example, in some embodiments, the gameplay model includes a large-language model (LLM) that can analyze, interpret, and summarize one or more of text, audio, images, and video.

In some embodiments, the gameplay model may be trained on data (e.g., images, video, player data, etc.) from a single game, resulting in a game-specific gameplay model. In other embodiments, the gameplay model may be trained on data (e.g., images, video, player data, etc.) from multiple games, of a single type or different types, resulting in a gameplay model that is tailored for a specific type of game or is game agnostic.

At 340, the process 300 receives runtime data (e.g., runtime data 425) from a gameplay session by a player of a video game.

In some embodiments, the runtime data may include images converted from live video (e.g., at a certain framerate, such as 10 frames per second, 30 frames per second, 60 frames per second, etc.), in-game sound and audio, live audio conversations between other players, and chat messages between other players. In some embodiments, the runtime data may also include gameplay data, including but not limited to game state data and metadata.

At 350, the process 300 provides the runtime data from the gameplay session of the video game as an input to the trained gameplay model.

At 360, the process 300, responsive to providing the input, receives output data (e.g., output data 430) as an output from the trained gameplay model.

In some embodiments, the output data includes a live game status. For example, the live game status may include one or more of a summary of the scene in the game, the position of the player in the scene, and the status of at least one NPC in the scene.

In some embodiments, the game may be a multiplayer game, where one or more other players are playing the game at the same time as the player during the gameplay session. The other players may be playing on the same team as the player, playing on an opposing team, or playing the game without being on a team. The other players may be represented in the game by player characters (PCs) that are visible to the player and can be interacted with, teamed with, and the like.

In some embodiments, the output data includes player character updates. For example, the player character updates may include summaries of positions of player characters during the gameplay session, summaries of actions by player characters during the gameplay session, and summaries of communications (audio conversations, chat messages, etc.) by player characters during the gameplay session. The player characters may include, but are not limited to, teammates of the player, opposing teammates of the player, and independent players of the game who are not on any team.

In some embodiments, the output data includes teammate updates. For example, the teammate updates may include summaries of positions of teammates during the gameplay session, summaries of actions by teammates during the gameplay session, and summaries of communications (audio conversations, chat messages, etc.) by teammates during the gameplay session.

The output data may also include predictive gameplay information or real-time gameplay recommendations based on the scene.

To continue the previous example of an American soccer video game, during the game session, the audience may shout “Hurray!” which the trained gameplay model may interpret to mean that a good action has occurred. A teammate may say to “turn right” to a player, which the trained gameplay model may interpret to mean that the player should move to the 1/3 right upper corner of the field. A player on an opposing team may say they are running to a fellow teammate's position, which the trained gameplay model may interpret to mean that the opposing player means to cut that teammate's ball passing. These interpretations can be made by the trained gameplay model and included in the output data.

At 370, the process 300 uses the output data, to generate an audio stream (e.g., audio stream 435) describing a context of the gameplay session. In some embodiments, the player may configure the context to their preferences. For example, the player may enable description only, so that the context may include game status and player conversation description. The player may enable recommendations, in which the other players and/or game sounds may be muted, and the context may only include consolidated information and movement instructions. The player may enable both description and recommendations, so that the context includes game sound as well as recommendations.

At 380, the process 300 provides the audio stream to a player who is playing the gameplay session. The audio stream may be a single voice channel that replaces all other audio sources, replaces some other audio sources, or is provided as an additional audio source. In some embodiments, the player may configure the audio stream to their preferences. For example, the player may enable description only, so that the audio stream may include game status and player conversation description. The player may enable recommendations, in which the other players and/or game sounds may be muted, and the audio stream may only include consolidated information and movement instructions. The player may enable both description and recommendations, so that the audio stream includes game sound as well as recommendations.

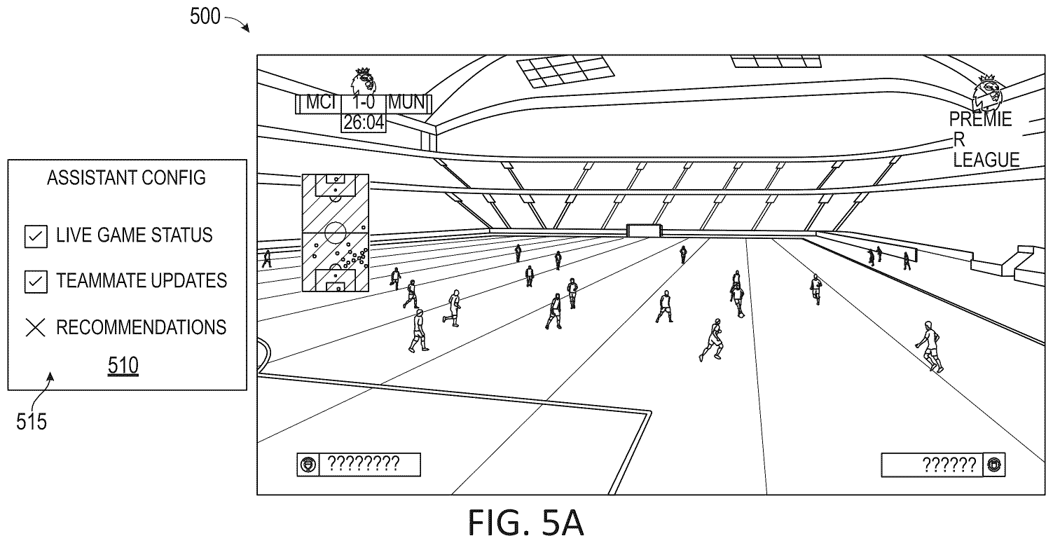

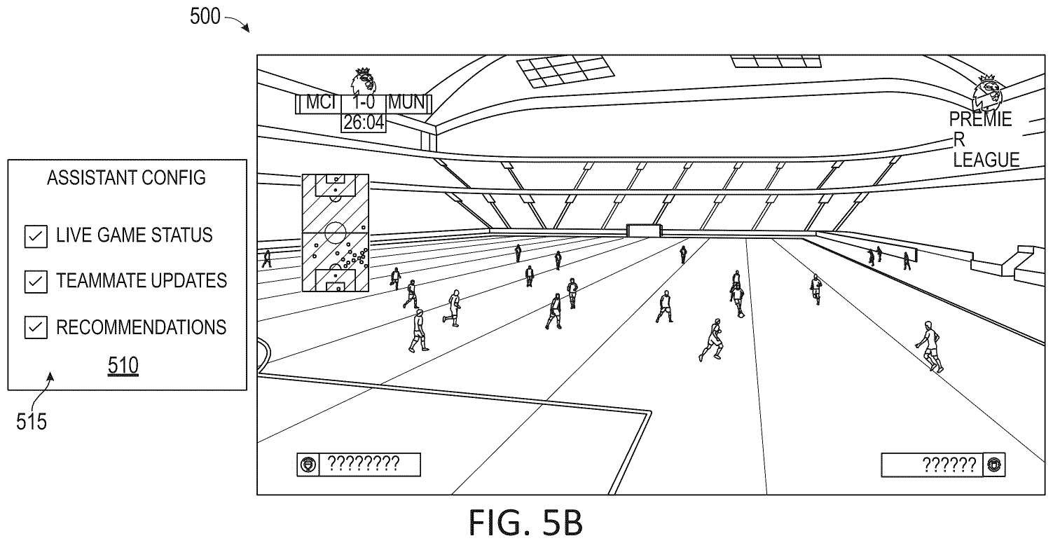

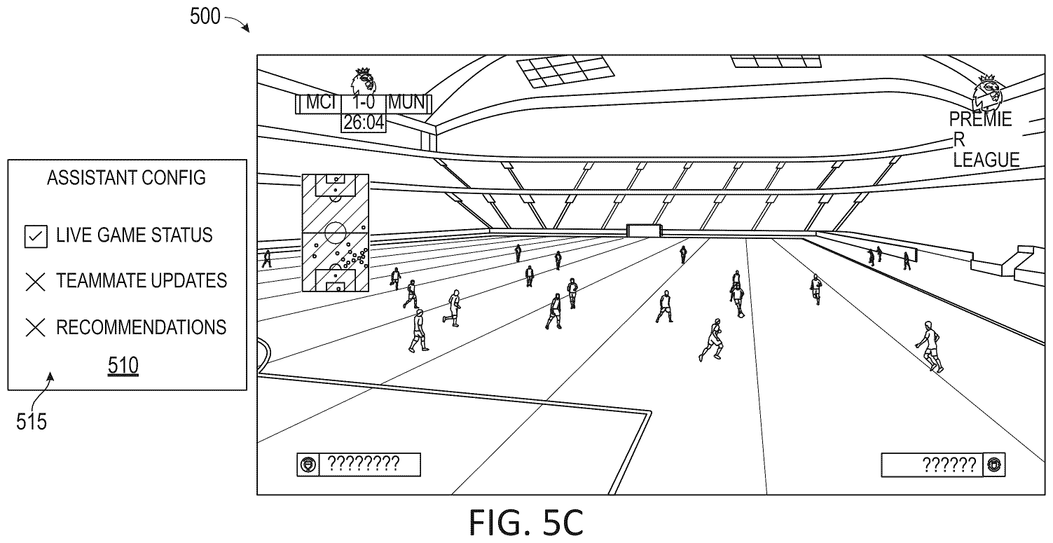

FIGS. 5A, 5B, and 5C exemplify embodiments of configuring an in-game video game assistant as an accessibility feature for a sports game 500, according to some embodiments. In some embodiments, one or more features of the video game assistant may be configured by the player among one or more in-game menus or settings. In this example, the player may use a menu 510 to select output options 515 that govern the assistant output. These output options 515 may include, but are not limited to, live game status, teammate updates, and recommendations.

FIG. 5A shows an example where the player has selected live game status and teammate updates but has not chosen recommendations. As a result of these settings, the assistant provides a single live voice output that replaces audio from the game to summarize game status and teammate updates. The output in this example may be, “Player M is at the left corner about 2 cm away from the goal gate, your teammates are moving towards you fast, reaching ETA of 1 second.”

FIG. 5B shows an example where the player has selected live game status, teammate updates, and recommendations. As a result of these settings, the assistant provides a single live voice output that replaces audio from the game to summarize game status and teammate updates, and also provide a recommendation. The output in this example may be, “Player M on the left corner aims to shoot, now move to your right by 5 cm quickly to meet your teammates and make a goal.”

FIG. 5C shows an example where the player has selected live game status but has not chosen teammate updates or recommendations. As a result of these settings, the assistant provides a live voice output that replaces game audio output to summarize game status, and the game's audio of the teammate conversation is also provided. The output from the asistant in this example may be, “Player M is at the left corner about 2 cm away from the goal gate, you are 5 cm away to his upper right.” Independently, the output from the game audio may include spoken words from a fellow teammate, such as, “Hey you run to Kylian now, I am cutting Player M's goal.”

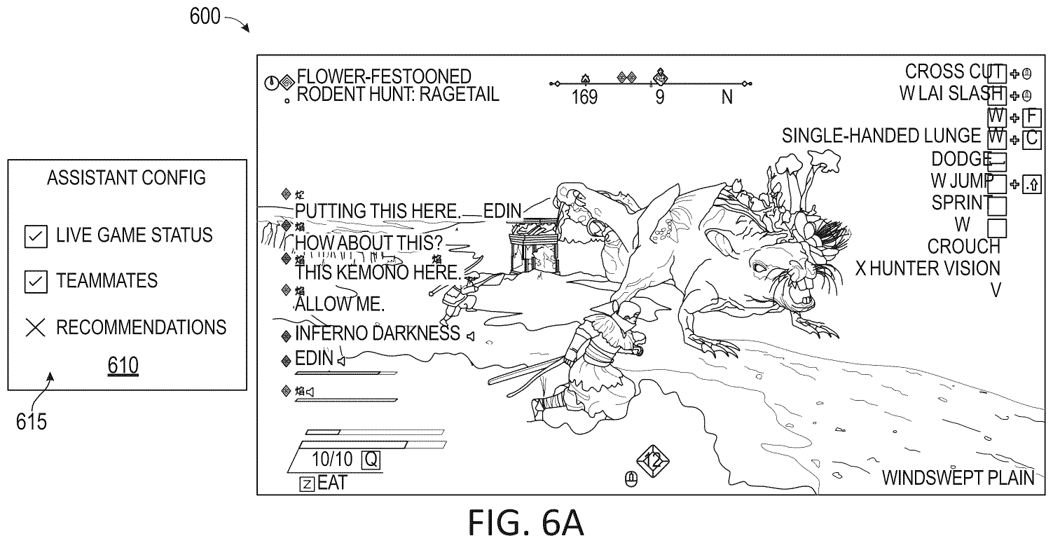

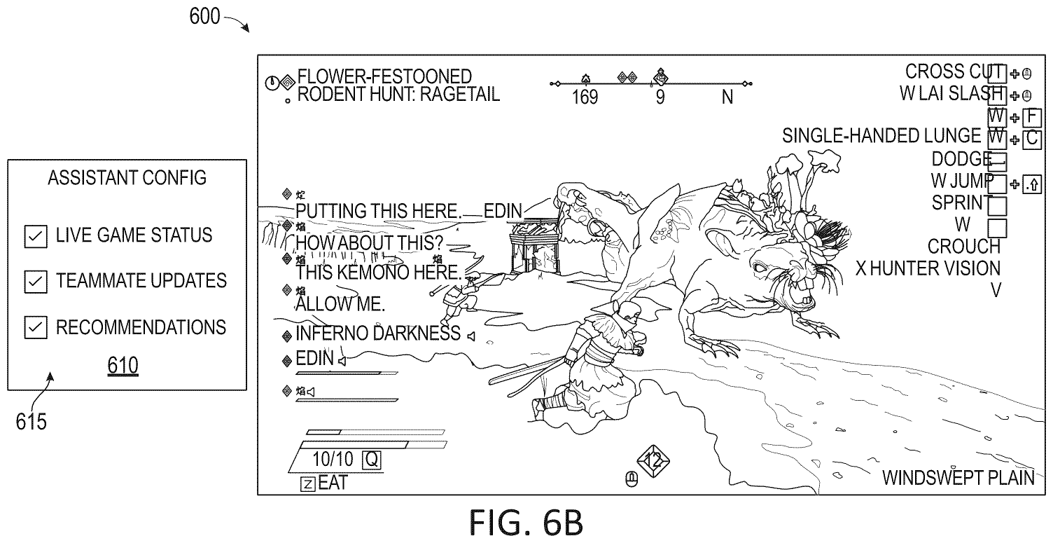

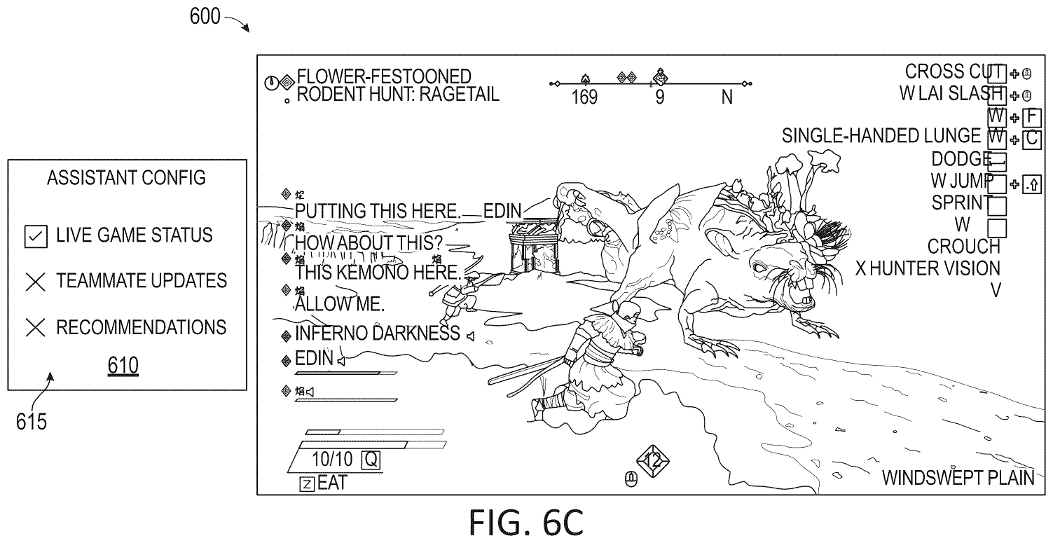

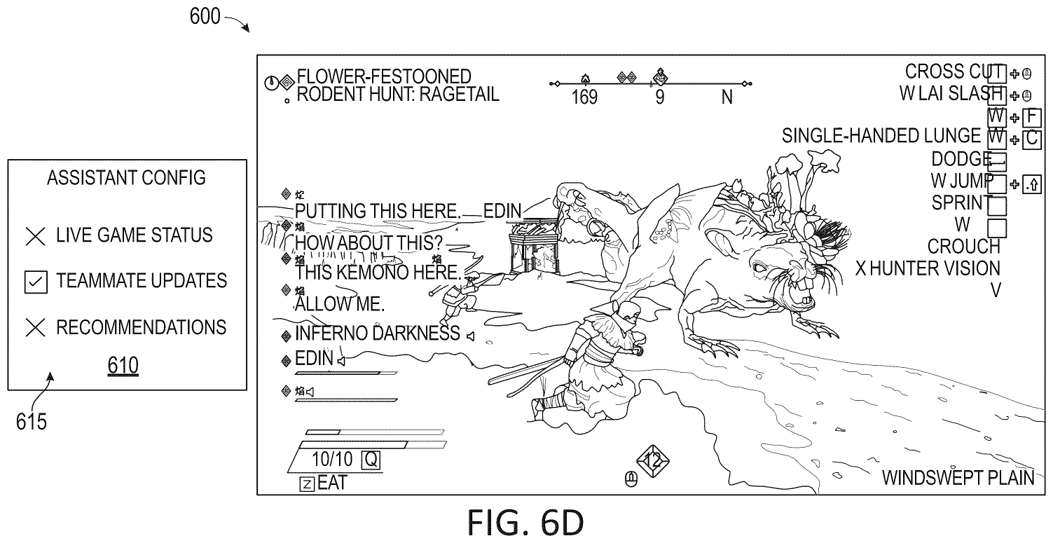

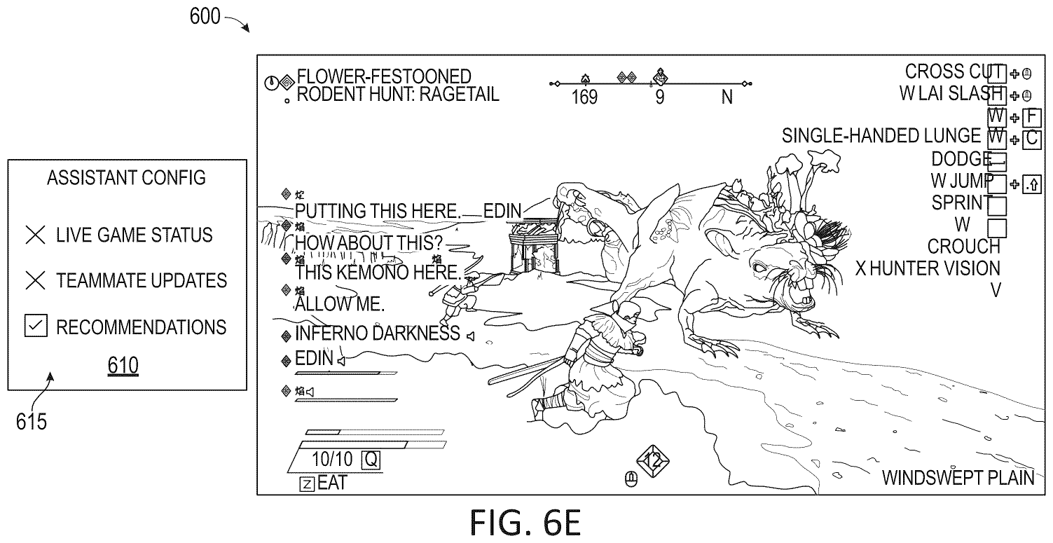

FIGS. 6A, 6B, 6C, 6D, and 6E exemplify embodiments of configuring an in-game video game assistant as an accessibility feature for a fantasy game 600, according to some embodiments. In some embodiments, one or more features of the video game assistant may be configured by the player among one or more in-game menus or settings. In this example, the player may use a menu 610 to select output options 615 that govern the assistant output. These output options 615 include, but are not limited to, live game status, teammate updates, and recommendations.

FIG. 6A shows an example where the player has selected live game status and teammate updates but has not chosen recommendations. As a result of these settings, the assistant provides a single live voice output that replaces audio from the game to summarize game status and teammate updates. The output in this example may be, “The monster is 2 feet in front of you. Your teammates are attacking at the monsters near you. They are both in a healthy status.”

FIG. 6B shows an example where the player has selected live game status, teammate updates, and recommendations. As a result of these settings, the assistant provides a single live voice output that replaces audio from the game to summarize game status, teammate updates, and a recommendation. The output in this example may be, “The monster is two feet in front of you and in a dangerous state. Set up a trap to attack or wait a bit for it to calm down.”

FIG. 6C shows an example where the player has selected live game status but has not chosen teammate updates or recommendations. As a result of these settings, the assistant provides a live voice output that summarizes game status, and the game's audio of the teammate conversation is also provided. The output from the assistant in this example may be, “The monster is 2 feet in front of you and has transformed into its dangerous state. ” Independently, the output from the game audio may include spoken words from a fellow teammate, such as “I'm setting up a trap for the monster. Once the monster steps into the trap, let's start our attack.”

FIG. 6D shows an example where the player has selected teammate updates but has not chosen live game updates or recommendations. As a result of these settings, the assistant provides a single live voice output that replaces audio from the game to summarize teammate updates. The output in this example may be, “Your teammates are attacking at the monsters near you. They are both in a healthy status.”

FIG. 6E shows an example where the player has selected recommendations but has not chosen live game status or teammate updates. As a result of these settings, the assistant provides a single live voice output that provides recommendations, and the game's audio of the teammate conversation is also provided. The output in this example may be, “The monster is two feet in front of you. Set up a trap to attack or wait a bit for it to calm down.” Independently, the output from the game audio may include spoken words from a fellow teammate, such as “I'm setting up a trap for the monster. Once the monster steps into the trap, let's start our attack.”

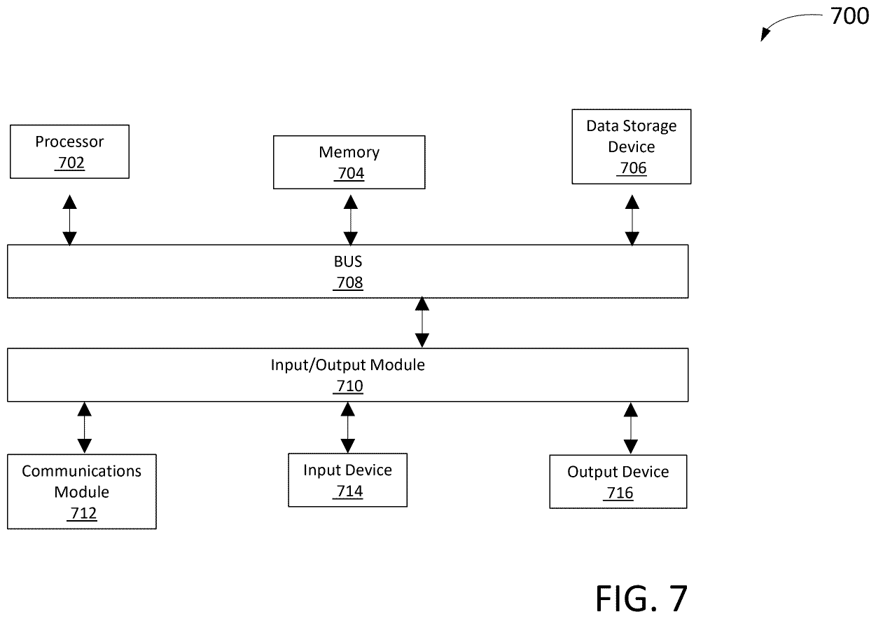

FIG. 7 is a block diagram illustrating an exemplary computer system 700 with which aspects of the subject technology can be implemented. In certain aspects, the computer system 700 may be implemented using hardware or a combination of software and hardware, either in a dedicated server, integrated into another entity, or distributed across multiple entities. As a non-limiting example, the computer system 700 may be one or more of the servers 130 and/or the client devices 110.

Computer system 700 includes a bus 708 or other communication mechanism for communicating information, and a processor 702 coupled with bus 708 for processing information. By way of example, the computer system 700 may be implemented with one or more processors 702. Processor 702 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 700 can include, in addition to hardware, code that creates an execution environment for the computer program in question, e.g., code that constitutes processor firmware, a protocol stack, a database management system, an operating system, or a combination of one or more of them stored in an included memory 704, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 708 for storing information and instructions to be executed by processor 702. The processor 702 and the memory 704 can be supplemented by, or incorporated in, special purpose logic circuitry.

The instructions may be stored in the memory 704 and implemented in one or more computer program products, i.e., one or more modules of computer program instructions encoded on a computer-readable medium for execution by, or to control the operation of, the computer system 700, and according to any method well-known to those of skill in the art, including, but not limited to, computer languages such as data-oriented languages (e.g., SQL, dBase), system languages (e.g., C, Objective-C, C++, Assembly), architectural languages (e.g., Java,. NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, Wirth languages, and xml-based languages. Memory 704 may also be used for storing temporary variable or other intermediate information during execution of instructions to be executed by processor 702.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 700 further includes a device for data storage 706 such as a magnetic disk or optical disk, coupled to bus 708 for storing information and instructions. Computer system 700 may be coupled via input/output module 710 to various devices. The input/output module 710 can be any input/output module. Exemplary input/output modules 710 include data ports such as USB ports. The input/output module 710 is configured to connect to a communications module 712. Exemplary communications modules 712 include networking interface cards, such as Ethernet cards and modems. In certain aspects, the input/output module 710 is configured to connect to a plurality of devices, such as an input device 714 and/or an output device 716. Exemplary input devices 714 include a keyboard and a pointing device, e.g., a mouse or a trackball, by which a user can provide input to the computer system 700. Other kinds of input devices 714 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 716 include display devices such as an LCD (liquid crystal display) monitor, for displaying information to the user.

According to one aspect of the present disclosure, the above-described systems can be implemented using a computer system 700 in response to processor 702 executing one or more sequences of one or more instructions contained in memory 704. Such instructions may be read into memory 704 from another machine-readable medium, such as data storage 706. Execution of the sequences of instructions contained in the memory 704 causes processor 702 to perform the process steps described herein. One or more processors in a multi-processing arrangement may also be employed to execute the sequences of instructions contained in memory 704. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 700 can include clients and servers. A client and server are generally remote from each other and typically interact through a communication network. The relationship of client and server arises by virtue of computer programs running on the respective computers and having a client-server relationship to each other. Computer system 700 can be, for example, and without limitation, a desktop computer, laptop computer, or tablet computer. Computer system 700 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 702 for execution. Such a medium may take many forms, including, but not limited to, non-volatile media, volatile media, and transmission media. Non-volatile media include, for example, optical or magnetic disks, such as data storage 706. Volatile media include dynamic memory, such as memory 704. Transmission media include coaxial cables, copper wire, and fiber optics, including the wires that comprise bus 708. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the computer system 700 reads application data and provides an application, information may be read from the application data and stored in a memory device, such as the memory 704. Additionally, data from the memory 704 servers accessed via a network, the bus 708, or the data storage 706 may be read and loaded into the memory 704. Although data is described as being found in the memory 704, it will be understood that data does not have to be stored in the memory 704 and may be stored in other memory accessible to the processor 702 or distributed among several media, such as the data storage 706.

Many of the above-described features and applications may be implemented as software processes that are specified as a set of instructions recorded on a computer-readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer-readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra-density optical discs, any other optical or magnetic media, and floppy disks. In one or more embodiments, the computer-readable media does not include carrier waves and electronic signals passing wirelessly or over wired connections, or any other ephemeral signals. For example, the computer-readable media may be entirely restricted to tangible, physical objects that store information in a form that is readable by a computer. In some embodiments, the computer-readable media is non-transitory computer-readable media, or non-transitory computer-readable storage media.

In one or more embodiments, a computer program product (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more embodiments are performed by one or more integrated circuits, such as application specific integrated circuits (ASICs) or field programmable gate arrays (FPGAs). In one or more embodiments, such integrated circuits execute instructions that are stored on the circuit itself.

Aspects of the present disclosure include machine learning. Machine learning is a subfield of artificial intelligence, which, to persons of ordinary skill of the art, corresponds to underlying algorithms and/or frameworks (commonly known as “neural networks” or “machine learning models”) that are configured and/or trained to perform and/or automate one or more tasks or computing processes. For simplicity, the terms “neural networks” and “machine learning models” can be used interchangeably and can be referred to as either “networks” or “models” in short.

Aspects of the present disclosure may include deep learning. Deep learning is a subfield of artificial intelligence and machine learning, which, to persons of ordinary skill of the art, corresponds to multilayered implementations of machine learning (commonly known as “deep neural networks”). For simplicity, the terms “machine learning” and “deep learning” can be used interchangeably.

As known to a person of ordinary skill in the art, machine learning is commonly used for performing and/or automating one or more tasks such as identification, classification, determination, adaptation, grouping, and generation, among other things. Common types (e.g., classes or techniques) of machine learning include supervised, unsupervised, regression, classification, reinforcement, and clustering, among others.

Machine learning model implementations among these types include linear regression, logistic regression, evolution strategies(ES), convolutional neural networks (CNN), deconvolutional neural networks (DNN), generative adversarial networks (GAN), recurrent neural networks (RNN), large language models (LLM), transformers, and random forest, among others. One or more machine learning model implementations can be trained and configured for performing or automating one or more tasks or processes during runtime.

As known to a person of ordinary skill in the art, the output of a machine learning model is based at least in part on its configuration and training data. The data that models are trained on (e.g., training data) can include one or more data types. In some embodiments, the training data of a model can be changed, updated, and/or supplemented throughout training and/or inference (i.e., runtime) of the model.

The systems, methods, and/or computing devices of the present disclosure can include machine learning modules. A “machine learning module” is a software module and/or hardware module including computer-executable instructions to configure, train, and/or deploy (e.g., execute) one or more machine learning models.

Some aspects of the present disclosure include subject matter corresponding to the gameplay of video game applications. As known to a person of ordinary skill in the art, the gameplay of a video game is commonly known as occurring among a game session within one or more instances of one or more virtual interactive environments. The gameplay of a video game provides interactivity with one or more aspects of a video game.

A game session may include a number of player characters and/or non-player characters. As known to those of skill in the art, player characters are character models that can be controlled or directed (at least primarily) by users or players through inputs at their respective computing devices, and can perform gameplay actions or commands. “Non-player characters” (also referred to herein as “NPCs”) are characters that are not or cannot be controlled and/or directed (primarily by users or players). Rather, NPCs can be configured with computer executable instructions to perform one or more gameplay tasks and/or actions, with and/or without the need for input or interaction from a user/player or player character.

A game session may include a number of player objects. Player objects can refer to controllable objects, or models, used to facilitate or enable gameplay or other in-game actions. Player objects may be, for example, vehicles, vessels, aircraft, ships, tiles, cards, dice, pawns, and other in-game items of the like known to those of skill in the art. In some embodiments, a user or player can control or direct one or more player objects in a game session, including, in some instances, by controlling player characters which in turn causes the objects to be controlled.

For simplicity, player characters and player objects disclosed are collectively referred to herein as player characters in some embodiments. It should be understood that, as used herein, “controllable” refers to the characteristic of being able and/or configured to be controlled and/or directed (e.g., moved, modified, etc.) by a player or user through one or more input means, such as a controller or other input device, by a player or user. As known to a person of ordinary skill in the art, player characters include character models configured to receive input.

Some aspects of the present disclosure include subject matter corresponding to data of video game applications. As known to a person of ordinary skill in the art, data of a video game application can include data such as state data, simulation data, rendering data, digital assets, and other data of the like.

State data is commonly known as data describing a state of a player character, virtual interactive environment, and/or other virtual objects, actors, or entities-in whole or in part-at one or more instances or periods of time during a game session of a video game. For example, state data can include the current location and condition of one or more player characters among a virtual interactive environment at a given time, frame, or duration of time or number of frames.

Simulation data is commonly known as the underlying data corresponding to simulation (e.g., physics and other corresponding mechanics) to drive the simulation of a model or object in a game engine. For example, simulation data can include the joint and structural configuration of a character model and corresponding physical forces or characteristics applied to it at instance or period of time during gameplay, such as a “frame”, to create animations, among other things.

Render Data is commonly known as the underlying data corresponding to rendering (e.g., visual and auditory rendering) aspects of a game session, which are rendered (e.g., for output to an output device) by a game engine. For example, render data can include data corresponding to the rendering of graphical, visual, auditory, and/or haptic output of a video game, among other things.

Digital game assets (or game assets in short) can include virtual objects, character models, actors, entities, geometric meshes, textures, terrain maps, animation files, audio files, digital media files, font libraries, visual effects, and other digital assets commonly used in video games of the like.

In some embodiments, a game session or gameplay is based in part on the data of a video game. One or more aspects of gameplay (e.g., rendering, simulation, state, gameplay actions of player characters) uses, produces, generates, and/or modifies game data. Likewise, gameplay events, objectives, triggers, and other aspects, objects, or elements of the like also use, produce, generate, and/or modify data of a video game.

The data of a video game may be updated, versioned, and/or stored periodically as a number of files to a computing device. Additionally, game data, or copies and/or portions thereof, can be stored, referenced, categorized, or placed into a number of buffers or storage buffers. A buffer can be configured to capture particular data, or data types, of game data for processing and/or storage.

Some aspects of the present disclosure include subject matter corresponding to video games, including video game components corresponding to the software of a video game. As known to a person of ordinary skill in the art, game code is software defining the gameplay, features, and aspects of a video game whereas a game engine provides underlying frameworks and software that support and facilitate execution of the game code (e.g., gameplay)

As a non-limiting descriptive example, a game engine includes, among other things, a renderer, simulator, and stream layer. A game engine uses game data (e.g., state data, render data, simulation data, audio data, and other data types of the like) to generate and/or render one or more outputs (e.g., visual output, audio output, and haptic output) for one or more computing devices. In some embodiments, a game engine is a distributable computer executable runtime portion of development software, such as a video game development engine.

A renderer is a graphics framework that manages the production of graphics corresponding to lighting, shadows, textures, user interfaces, and other effects to game assets of the like among a game engine. A simulator refers to a framework that manages simulation aspects corresponding to physics and other corresponding mechanics used in part for animations and/or interactions of gameplay objects, entities, characters, lighting, gasses, and other game assets or effects of the like. A stream layer is a software layer that allows a renderer and simulator to execute independently of one another among a game engine by providing a common execution stream for renderings and simulations to be produced and/or synchronized (e.g., scheduled) at and/or during runtime.

A game engine also includes an audio engine or audio renderer that produces and synchronizes audio playback with or among the common execution of a stream layer.

For example, an audio engine of a game engine can use game data to produce audio output and/or haptic output from game data.

As used herein in some embodiments, video game applications can also use and/or include Software Development Kits (SDKs), Application Program Interfaces (APIs), Dynamically Linked Libraries (DLLs), and other software libraries, components, modules, shims, or plugins that provide and/or enable a variety of functionality; such as-but not limited to-graphics, audio, font, or communication support, establishing and maintaining service connections, performing authorizations, and providing a video game assistant for context and recommendations, among other things.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon implementation preferences, it is understood that the specific order or hierarchy of blocks in the processes may be rearranged, or that not all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject technology is illustrated, for example, according to various aspects described above. The present disclosure is provided to enable any person skilled in the art to practice the various aspects described herein. The disclosure provides various examples of the subject technology, and the subject technology is not limited to these examples. Various modifications to these aspects will be readily apparent to those skilled in the art, and the generic principles defined herein may be applied to other aspects.

A reference to an element in the singular is not intended to mean “one and only one” unless specifically stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the disclosure.

To the extent that the terms “include,” “have,” or the like is used in the description or the claims, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments. In one aspect, various alternative configurations and operations described herein may be considered to be at least equivalent.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in the claims that follow, are approximate, not exact. In one aspect, they are intended to have a reasonable range that is consistent with the functions to which they relate and with what is customary in the art to which they pertain. It is understood that some or all steps, operations, or processes may be performed automatically, without the intervention of a user.

Method claims may be provided to present elements of the various steps, operations, or processes in a sample order, and are not meant to be limited to the specific order or hierarchy presented.

In one aspect, a method may be an operation, an instruction, or a function and vice versa. In one aspect, a claim may be amended to include some or all of the words (e.g., instructions, operations, functions, or components) recited in other one or more claims, one or more words, one or more sentences, one or more phrases, one or more paragraphs, and/or one or more claims.

All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S. C. § 112, sixth paragraph, unless the element is expressly recited using the phrase “means for” or, in the case of a method claim, the element is recited using the phrase “step for.”

The Title, Background, and Brief Description of the Drawings of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples, and the various features are grouped together in various embodiments for the purpose of streamlining the disclosure. This method of disclosure is not to be interpreted as reflecting an intention that the included subject matter requires more features than are expressly recited in any claim. Rather, as the claims reflect, inventive subject matter lies in less than all features of a single disclosed configuration or operation. The claims are hereby incorporated into the Detailed Description, with each claim standing on its own to represent separately patentable subject matter.

The claims are not intended to be limited to the aspects described herein but are to be accorded the full scope consistent with the language of the claims and to encompass all legal equivalents. Notwithstanding, none of the claims are intended to embrace subject matter that fails to satisfy the requirement of 35 U.S. C. § 101, 102, or 103, nor should they be interpreted in such a way.

It should be understood that the original applicant herein determines which technologies to use and/or productize based on their usefulness and relevance in a constantly evolving field, and what is best for it and its players and users. Accordingly, it may be the case that the systems and methods described herein have not yet been and/or will not later be used and/or productized by the original applicant. It should also be understood that implementation and use, if any, by the original applicant, of the systems and methods described herein are performed in accordance with its privacy policies. These policies are intended to respect and prioritize player privacy, and to meet or exceed government and legal requirements of respective jurisdictions. To the extent that such an implementation or use of these systems and methods enables or requires processing of user personal information, such processing is performed (i) as outlined in the privacy policies; (ii) pursuant to a valid legal mechanism, including but not limited to providing adequate notice or where required, obtaining the consent of the respective user; and (iii) in accordance with the player or user's privacy settings or preferences. It should also be understood that the original applicant intends that the systems and methods described herein, if implemented or used by other entities, be in compliance with privacy policies and practices that are consistent with its objective to respect players and user privacy.

Embodiments consistent with the present disclosure may be combined with any combination of features or aspects of embodiments described herein.

1. A method, comprising:
receiving runtime data from a gameplay session by a player of a video game;
providing the runtime data from the gameplay session of the video game as an input to a gameplay model;
responsive to providing the input, receiving output data from the gameplay model;
using the output data, generating an audio stream describing a context of the gameplay session; and
providing the audio stream to the player of the video game during the gameplay session.

2. The method of claim 1, wherein the gameplay model comprises a large-language model (LLM).

3. The method of claim 1, wherein the runtime data comprises one or more of in-game images from the gameplay session, in-game video from the gameplay session, in-game audio from the gameplay session, audio conversations during the gameplay session, and chat messages during the gameplay session.

4. The method of claim 1, wherein the context comprises a live game status, wherein the live game status comprises one or more of a summary of a scene in the video game, a position of the player in the scene, and a status of at least one NPC in the scene.

5. The method of claim 1, further comprising receiving a selection by the player to configure the output data.

6. The method of claim 5, wherein the selection comprises enabling player character updates, the context comprises a plurality of player character updates during the gameplay session, and the method further comprises disabling game audio output associated with player character updates.

7. The method of claim 6, wherein the plurality of player character updates comprise one or more of summaries of positions of player characters during the gameplay session, summaries of actions by player characters during the gameplay session, and summaries of communications by player characters during the gameplay session.

8. The method of claim 5, wherein the selection comprises enabling recommendations, and the context comprises gameplay recommendations to the player during the gameplay session.

9. The method of claim 8, wherein the context further comprises predictive gameplay information to assist the player during the gameplay session.

10. The method of claim 1, further comprising:
receiving a plurality of in-game images and video from a plurality of previous game sessions of at least one video game;
receiving a plurality of in-game player data from the plurality of previous game sessions of the at least one video game; and
training the gameplay model using the plurality of in-game images and video and the plurality of in-game player data.

11. The method of claim 10, wherein the plurality of in-game images and video depict one or more of images of player characters (PCs), images of non-player characters (NPCs), names of player characters (PCs), names of non-player characters (NPCs), actions of player characters (PCs), actions of non-player characters (NPCs), gameplay scenes, and game locations.

12. The method of claim 10, wherein the plurality of in-game player data is associated with a plurality of players of the at least one video game during the plurality of previous game sessions, and the plurality of in-game player data comprises one or more of descriptions of actions of at least one player, descriptions of locations of the at least one player, communications between the plurality of players, and descriptions of gameplay strategy by at least one player.

13. A non-transitory computer-readable medium storing a program, which when executed by a computer, configures the computer to:
receive runtime data from a gameplay session by a player of a video game;
provide the runtime data from the gameplay session of the video game as an input to a gameplay model;
responsive to providing the input, receive output data from the gameplay model;
using the output data, generate an audio stream describing a context of the gameplay session; and
provide the audio stream to the player of the video game during the gameplay session.

14. The non-transitory computer-readable medium of claim 13, wherein the runtime data comprises one or more of in-game images from the gameplay session, in-game video from the gameplay session, in-game audio from the gameplay session, audio conversations during the gameplay session, and chat messages during the gameplay session.

15. The non-transitory computer-readable medium of claim 13, wherein the context comprises a live game status, wherein the live game status comprises one or more of a summary of a scene in the video game, a position of the player in the scene, and a status of at least one NPC in the scene.

16. The non-transitory computer-readable medium of claim 13, wherein the program, when executed by the computer, further configures the computer to:
receive a selection by the player to configure the output data, the selection comprising enabling player character updates, and the context comprising a plurality of player character updates during the gameplay session; and
disable game audio output associated with the player character updates,
wherein the plurality of player character updates comprise one or more of summaries of positions of player characters during the gameplay session, summaries of actions by player characters during the gameplay session, and summaries of communications by player characters during the gameplay session.

17. The non-transitory computer-readable medium of claim 13,
wherein the program, when executed by the computer, further configures the computer to receive a selection by the player to configure the output data, the selection comprising enabling recommendations, and the context comprising gameplay recommendations to the player during the gameplay session and predictive gameplay information to assist the player during the gameplay session.

18. The non-transitory computer-readable medium of claim 13, wherein the program, when executed by the computer, further configures the computer to:
receive a plurality of in-game images and in-game video from a plurality of previous game sessions of at least one video game;
receive a plurality of in-game player data from the plurality of previous game sessions of the at least one video game; and
train the gameplay model using the plurality of in-game images and video and the plurality of in-game player data.

19. A system, comprising:
a processor; and
a non-transitory computer-readable medium storing a set of instructions, which when executed by the processor, configure the system to:
receive runtime data from a gameplay session by a player of a video game;
provide the runtime data from the gameplay session of the video game as an input to a gameplay model;
responsive to providing the input, receive output data from the gameplay model;
using the output data, generate an audio stream describing a context of the gameplay session; and
provide the audio stream to the player of the video game during the gameplay session,
wherein the runtime data comprises one or more of in-game images from the gameplay session, in-game video from the gameplay session, in-game audio from the gameplay session, audio conversations between players during the gameplay session, and chat messages between players during the gameplay session, and
wherein the context comprises a live game status, wherein the live game status comprises one or more of a summary of a scene in the game, a position of the player in the scene, and a status of at least one NPC in the scene.

20. The system of claim 19, wherein the instructions, when executed by the processor, further configure the system to:
receive a selection by the player to configure the output data, the selection comprising enabling player character updates and enabling recommendations, and the context comprising a plurality of player character updates during the gameplay session and further comprising gameplay recommendations to the player during the gameplay session; and
disable game audio output associated with the player character updates.
